(19) United States
(12) Patent Application Publication
(10) Pub. No.: US 2026/0127086 A1
(43) Pub. Date: May 7, 2026

(54) METHOD FOR TESTING A LARGE LANGUAGE MODEL IMPLEMENTED IN A CONVERSATIONAL AGENT

(71) Applicant: GISKARD AI, PANTIN (FR)

(72) Inventors: Kevin MESSIAEN, HEM (FR); Pierre LE JEUNE, PARIS (FR); Matteo DORA, PARIS (FR); Jean-Marie JOHN MATHEWS, AVON (FR)

(21) Appl. No.: 18/965,099

(22) Filed: Dec. 2, 2024

(30) Foreign Application Priority Data
Nov. 7, 2024 (FR) 2412218

(51) Int. Cl. G06F 11/34; G06F 16/955; G06F 40/40

(52) U.S. Cl. CPC G06F 11/3409; G06F 16/955; G06F 40/40

(57) ABSTRACT

A computer-implemented method for testing the performance of a large language model includes receiving a set of data from at least one data source over a period of time; generating at least a first message from the received data set and by applying at least a first large variation language model; generating a plurality of messages by applying at least one large variation language model; generating a plurality of message exchanges by applying a large language model to be tested; calculating a first error indicator, and calculating a second compliance indicator.

### CROSS-REFERENCE TO RELATED APPLICATIONS

This application claims priority to French Patent Application No. 2412218, filed Nov. 7, 2024, the entire content of which is incorporated herein by reference in its entirety.

### FIELD

The field of the invention relates to that of automatically generated tests of conversational agents implementing large language models in order to enhance their robustness over time.

### BACKGROUND

Currently, there are solutions that enable interaction with a conversational agent, called a “chatbot”, to help a human gather specific information. These conversational agents require contextual accuracy, depending on how they are to be used. A well-known problem is the ability of a conversational agent to offer a persistent service over time, capable of taking into account variations linked to new concepts, new concepts emanating from news published on data sources accessible from a data exchange network such as the Internet.

### SUMMARY

According to a first aspect, the invention relates to a computer-implemented method for testing the performance of a large language model implemented within a conversational agent, the method comprising:
Receipt of a set of data from at least one data source, said data corresponding to an encoding of sequences of discrete symbols in natural language, the set of data being previously extracted from at least a data source automatically at a given frequency and from a selection of a natural language;
Generation of at least a first test message from the received data set by applying at least a first large language model configured with a main context comprising a definition of a language and a given instruction specific to the data source;
Generation of a plurality of variation sequences by application of at least one plurality of large variation language models configured on the basis of a plurality of secondary contexts making it possible to generate, on the one hand, the variations of the first test message and the associated responses generated by at least one large language model;
Generation of a plurality of message sequences by applying a large language model to be tested, a sequence comprising an input and the corresponding generated output of a large language model;
Calculation of a first error indicator evaluating a set of error criteria by comparing sequences produced by the large language model to be tested and sequences of variations;
Calculation of a second conformance indicator from a conformance domain comprising conformance rules defining validity sets of sequences produced by the large language model to be tested.

In an embodiment, the invention comprises computing errors by comparing the output of the tested model and the expected output.

A benefit of the invention is that it enables the robustness of a conversational agent to be assessed over time by automatically generating tests. In an embodiment, these tests are used to diagnose and identify validity domains of a conversational agent. The tests also make it possible to redefine or specify a conversational agent prompt so that it can automatically generate reliable responses.

According to an embodiment, variation sequence responses are generated by the plurality of large variation language models. A benefit is to extend the test domain.

According to an embodiment, the responses of the variation sequences are generated by at least one large evaluation language model that considers as input a variation produced by a large variation language model and produces as output an associated response.

In an embodiment, the first message is a first sequence of natural language symbols defining a question in a natural language.

In an embodiment, the process is run at a predefined frequency on a set of predefined sources.

In an embodiment, frequency is used to select data from published data sources from a given date.

In an embodiment, each source is associated with a given frequency.

In an embodiment, the data source is pre-selected from a uniform resource locator within a data network and an organization name for selecting a subset of the data accessible from the uniform resource locator.

According to an embodiment, the data reception comes from one of the data sources characterized by:
A data source accessible from a social network using an authentication process;
A data source defining comments or opinions from a plurality of individuals;
An open-access information data source;
A data source defining one or more databases internal to an organization, such as a product or item database, a service database, or a stock vehicle database;
A data source defining conversational agent(s) conversation data recorded in production or in a test environment,
A data source defining electronic documentation.

A benefit is that one can generate tests that are heterogeneous thanks to the diversity of the sources selected.

In an embodiment, the method comprises generating an alert when at least a first error indicator and/or a second compliance indicator is generated.

In an embodiment, the method comprises configuring access to a data source.

According to an embodiment, the method comprises the execution of a large data processing language model of the sources in order to filter, format and/or normalize the data sets extracted from the data sources.

A benefit is to obtain messages that simulate a type of question likely to arise, for example by automatically introducing a personal pronoun such as “I”.

In an embodiment, each exchange sequence comprises a sequence of natural language symbols defining a question, said sequence of natural language symbols being generated from at least a first large variation language model and an answer generated using a large test language model.

According to an embodiment, the main context of a first large variation language model comprises the definition of a domain associated with a lexical field or a set of keywords. The context is, for example, an LLM prompt.

In an embodiment, a first large variation language model comprises a context configured to automatically generate a sequence of discrete symbols in a natural language from one or more paraphrases of the first message.

In an embodiment, a second large variation language model comprises a context configured to automatically generate a sequence of discrete symbols in a natural language from a translation of the first message into another natural language.

In an embodiment, a third major variation language model comprises a context configured to automatically generate a sequence of discrete symbols in a natural language from an exaggeration of the first message.

In an embodiment, a fourth major variation language model comprises a context configured to automatically generate a sequence of discrete symbols in a natural language from a change in tone compared with the first message.

In an embodiment, a fifth major variation language model comprises a context configured to automatically generate a sequence of discrete symbols in a natural language from an introduction of at least one insult in the first message.

According to an embodiment, a sixth major variation language model comprises a context configured to automatically generate a sequence of discrete symbols in a natural language from an introduction of at least one error in the first message, said error being, for example, a spelling or grammatical error in a natural language.

In an embodiment, the method comprises generating a plurality of message variations for each large language variation model.

A benefit is the ability to generate a very wide variety of unit tests from a test LLM based on message variations with great heterogeneity and context diversification, and taking into account data that evolves over time.

According to an embodiment, the conformance domain is defined from the response of a third large language model configured from a context defining a conformance domain.

In an embodiment, the conformance domain is defined from a set of rules defining validity sets of predefined natural language symbol sequences and/or invalidity sets of predefined natural language symbol sequences.

According to an embodiment, the set of rules includes the specification of a response language, the specification of topics to be excluded from the response field or that a link to a data network resource must be present in a given response type.

According to an embodiment, the set of rules defining disability sets comprises a knowledge base listing a set of themes, categories, labels or keywords each defining a sequence of discrete symbols in a natural language and possibly variations of this sequence.

In an embodiment, the conformance domain is generated partly automatically from the organization name, rules and main context of the first large language model.

According to an embodiment, an error criterion of the first error indicator comprises a check that a set of concepts in common are present on the one hand in the response produced by the variation sequence produced and on the other hand in the response produced by the large language model to be tested to which a variation of the first message has been supplied.

In an embodiment, when an error indicator and/or a compliance indicator is generated, a notification is automatically sent to a remote server or a memory resource of the equipment on which the process is running.

According to an embodiment, when an error indicator and/or a compliance indicator is generated, an error counter is generated to produce an evaluation of the conversational agent over a given period of time.

According to another aspect, the invention concerns a system comprising an electronic user terminal comprising a user interface, at least one data server hosting all or part of a first data source, a second data server comprising at least one calculator and a memory within which the large language model to be tested is executed and at least one third data server comprising a device for executing a variation language model and comprising a calculator for executing the steps of the method of the invention.

In an embodiment, the system comprises a fourth data server with at least one computer and a memory in which the large evaluation language model is executed.

### BRIEF DESCRIPTION OF FIGURES

Further features and benefits of the invention will become apparent from the following detailed description, with reference to the appended figures, which illustrate:

FIG. 1: a method of carrying out the process steps of the invention;

FIG. 2: an embodiment of a system of the invention.

### DETAILED DESCRIPTION

An LLM is a “large language model”. Such a model is a machine learning model with a large number of parameters. In some embodiments, these are deep neural networks trained on large quantities of unlabeled text using self-supervised learning or semi-supervised learning.

A “large language model to be tested” is an LLM operated by a conversational agent whose limits, edge effects and robustness in producing consistent, true and unbiased responses over time are to be tested. It is noted LLMₜ.

A “large variation language model” is an LLM configured to

produce variations of a text from a given parameterization. It is referred to as aᵥₖ LLM according to the i^{th} LLM of variation with a given parameterization. When the text is a question, the LLMᵥₖ produces the variation of the question with respect to an original question, and possibly the answer to the variation. In the latter case, an LLMᵥₖ produces a sequence of variations SEQ_{VARi} including a first message defining an input to the large variation language model LLMᵥₖ, for example in the form of a question, and including a response to the first message produced by the LLMᵥₖ.

A “large evaluation language model” or “large reference language model” is an LLM configured to compare the result produced in response to a query with the result produced when executing a large test language model LLMₜ subjected to the same query/input. This large reference/evaluation language model is referred to as LLMₑ. According to an embodiment, a large evaluation language model LLMₑ may be of the same type as the same large variation language model LLMᵥₖ used to generate the VARᵢ variations according to a given criterion which produces the inputs and outputs of the LLMk from a message M1, however the prompt of a large evaluation language model LLMₑ differs from the prompt of a large variation language model LLMᵥₖ.

In the latter case, the method of an embodiment of the invention enables the result of an execution of the LLMₜ test model to be compared with that generated by the LLMᵥᵢ variation LLM. Comparisons are only based on the responses produced by each LLMₜ model, respectively LLMᵥₖ from different or the same inputs.

An LLM configured to process data extracted from data sources by homogenizing, normalizing, filtering or formatting the data according to a given LLM context setting is called a “large source data processing language model”.

An LLM “context” is a “prompt” used to specify or parameterize a textual description of the task to be performed by a machine learning algorithm such as an LLM. In an embodiment a prompt is set from a user interface or directly programmed in a programming language. In the context of the invention, a “configured LLM” refers to an LLM for which the prompt or context is parameterized or specified.

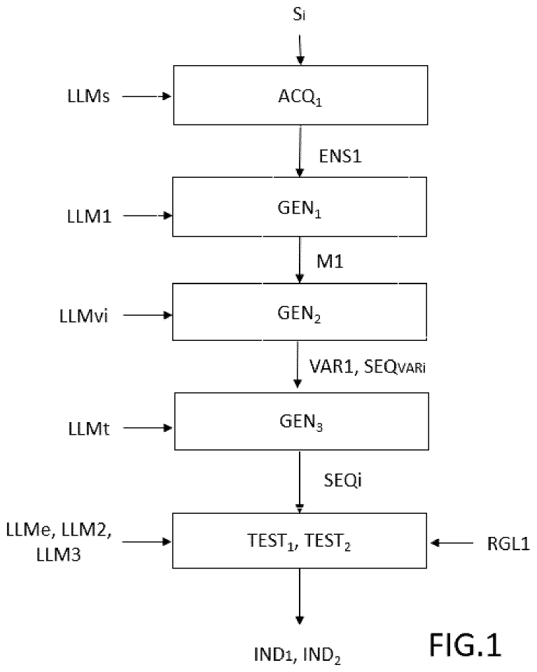

FIG. 1 shows an example of how the process of an embodiment of the invention is implemented. The example is detailed for an organization having a designation and, for example, an identifier. In the example, the organization operates a conversational agent implemented within a digital service offered to a plurality of users. The service is accessible from at least one SERV₁ data server. Users access the service from a PC client, which is for example an electronic terminal such as a PC, tablet, smartphone or ordiphone.

An organization can be a company, an association, an individual, a laboratory or any other form of community of users who have jointly defined a digital service accessible from a NET₁ data network, such as the Internet.

According to various examples, the organization may be a public service, an insurer, a bank, a school, a tour operator, etc. offering a digital service accessible from a NET data network₁. The digital service may be open, with free access via a URL (Uniform Resource Locator). Such access enables data to be accessed within a NET data network₁. In another example, the digital service can be closed and put online within a private data network, such as an intranet or a network requiring user authentication.

For each organization, and therefore for each identifier representing an organization, the method aims to retrieve data from a set of data sources Sᵢ in order to test the performance and robustness of an LLMₜ conversational agent. By “performance of a conversational agent”, we mean its ability to produce structured, coherent, true answers, or to address a given answer to a given question, or even sometimes to redefine the perimeter or domain in which it is capable of answering in order for a user to reformulate a question, and so on.

A conversational agent is generally implemented on the basis of an LLM configured in a particular domain. To this end, a context, also known as a “prompt”, is used to enrich the training domain of the machine learning algorithm, for example. The process of the invention makes it possible to update the domain over time from a set of data sources evolving over time and test the domain so that it is able to maintain or improve its performance in a domain over time.

### Receiving Data From Sources

An embodiment of the invention's process enables tests to be generated automatically, covering specific features of a given field of use that may evolve over time. One of the aspects of the invention is to set up an automated active monitoring of contexts via heterogeneous sources that evolve over time.

To this end, the method of the invention comprises a first step AQC₁ which corresponds to the reception of a set of data ENS₁ from at least one data source Sᵢ.

The ENS dataset₁ comprises a set of natural language symbol sequences. These sequences may correspond to a word, a number or a figure, a sentence, a paragraph comprising a plurality of sentences, a text from a document such as a file in .docx, .pdf or any other text format, or a web page in html, xml or any other format enabling data to be contained and structured and displayed in a browser.

In an embodiment, Sᵢ sources correspond to different data containers accessible from different digital resource locators noted URLᵢ within a NET₁ data network, such as the Internet. In an embodiment, the i^{th} data source Sᵢ is accessed from a URLᵢ. According to an example, an Sᵢ source is accessed only by means of a URLᵢ resource locator. According to another example, Sᵢ sources are accessed by means of a URLᵢ resource locator and at least one other data item. In a first example, authentication data is used to access an Sᵢ data source. The authentication data may be, for example, a login and password or two-factor authentication or any other means of identification or authentication. According to an example, the source Sᵢ is a URL of an organization's web page.

In an embodiment, the data source is a database internal to an organization, such as a product or item database, a service database, an electronic documentation database or a vehicle inventory database. Any other type of database can be configured to define a usable data source.

According to another example, the data source corresponds to conversational agent(s) conversation data recorded in production or in a test environment. This makes it possible to use the themes actually produced by users of the conversational agent as a source of data generation.

According to an example, the data source Sᵢ corresponds to a portion of the data accessible from a URLᵢ resource locator via a NET₁ data network. The part may correspond to a set of comments or notices on a web page, a title of an article, an article.

According to an embodiment, a given configuration is used to parameterize the data that is extracted from a given source Sᵢ. In an embodiment, if a plurality of data sources Sᵢ is used in the execution of the method of the invention, then a plurality of parameterizations is carried out so that data ENS₁ from each source Sᵢ is received. In an embodiment, the reception, collection and storage of the data are carried out within a SERV₁ data server. According to an example, each setting comprises at least the name of an organization, a URL and a frequency for defining a data retrieval period within the data source.

In an embodiment, the data is received by at least one memory of an electronic terminal such as a computer or server. According to various embodiments, the equipment receiving the data from each source Sᵢ is an

equipment comprising at least a memory and a computer. The ENS₁ data is received and stored for processing by a computer. According to an example, a database is implemented and operated to store the ENS₁ data from the various Sᵢ sources in an ordered manner. According to an example, the database enables data to be stored and ordered chronologically, so that it is possible to check whether the data from an Sᵢ source has changed over time, and if so, to compare the extent to which it has changed between two different points in time.

In an embodiment, the ENS₁ data is received at regular time intervals, for example according to a predefined period; a period of the order of an hour, a day, a week or a month, or even a year is defined.

According to an embodiment, data reception is preceded by a step initiated by a given piece of equipment generating queries to the various sources Sᵢ to extract data present in each source Sᵢ. In an example where a server is configured to retrieve data from the various Sᵢ sources, queries are defined to periodically retrieve data from different sources distributed on and accessible from a NET₁ data network.

According to an embodiment, an analysis function is executed on the SERV₁ server to analyze whether an ENS₁ data set is registered and exploited by the method of the invention, or whether it is not registered. In an embodiment, certain criteria is/are defined in order to parameterize the analysis function. For example, the analysis function compares topics, themes, keywords, concepts or calculates a similarity score between two sets retrieved at two different dates or between the data set and a reference set.

An interest is to retrieve data from a set of Sᵢ sources that are heterogeneous in order to generate different varieties of questions defining inputs to the conversational agent to test its robustness to different variations likely to occur over time depending on themes and topics related to current events, for example.

In an embodiment, a set of queries are generated to retrieve a wide variety of data sets from different sources.

We understand that textual data from comments or opinions will not be formulated in the same way as a website publishing institutional information or editorial digital reviews. Differences in tone, different registers of language—including colloquial and sustained language—and the presence or absence of spelling errors, mean that different inputs can be generated, enabling the large language model to be widely tested LLMₜ. Finally, an interest in retaining data presenting a topic update according to publication date enables the context to be continuously updated and therefore the set of data defining a conversational agent's prompt to be updated and, more generally, to check that the LLMₜ conversational agent has access to up-to-date data.

### Test Message Generation Step

The method comprises a second step of generating at least a first message M₁ from the received data set ENS₁ and by applying at least a first large language model LLM₁ configured with a main context CT₁ comprising a definition of a language and a description defining an instruction. In the most general case, the process generates a plurality of messages M₁ so that different tests of the large language model to be tested LLMₜ are carried out.

In this step, the process of an embodiment of the invention implements a machine learning algorithm to produce a question directly usable by the LLMₜ conversational agent to be tested. A benefit of exploiting a large number of heterogeneous sources is to produce a variety of test questions for testing an LLMₜ to be tested. The LLM₁ is configured to generate questions for the LLMₜ.

In order to generate questions that can be used to effectively test the conversational agent to be tested by LLMₜ, a context is defined to format the question to be generated in a given domain and language.

In particular, the language can be used to extract data in the configured language, or to translate the content of the extracted and received ENS₁ data for testing the LLMₜ in the specified language.

The domain may relate to a general field, such as science, economics or politics, or to a specific trade, such as banking, crafts, perfumery, insurance, or automobiles. In addition, the domain may relate to an activity of an organization, such as a retail activity, a training activity, a service activity, and so on.

A benefit is that the question can be customized to a given field. For example, the domain could be “after-sales service for cosmetics”, or “assistance for people who have suffered an accident”, or even “medical pre-diagnosis to refer an individual to the appropriate emergency service”.

In these cases, the data extracted from ENS₁ is used to generate a domain-specific input using LLM₁.

For example, if a data source Sᵢ specifies that “insurance reimbursement rates for a drug have dropped from 100% to 50%”, and the domain is “assistance to people who have suffered an accident”, the LLM₁ can generate a question such as: “Can I benefit from a 100% reimbursement rate for my care in the case of an accident at work?”. In this way, the LLM₁ is configured to generate first-person answers applied to the case of assistance or assumption of responsibility, taking into account the data produced by the data source in question.

### Variation Generation

According to an embodiment, at least one machine learning algorithm such as a large LLM_{V1} language model is configured to generate variations of the test message M₁. The variations generated are denoted VARᵢ. A benefit of generating VARᵢ variations is that it enables the testing domain of a conversational agent to be extended, said conversational agent implementing a large LLMₜ language model to be tested. The variations correspond to variations of the message M₁. In an embodiment, each large variation language model LLMᵥᵢ generates a sequence SEQ_{VARi} comprising the variation VARᵢ of the message M₁ and the associated response.

According to an embodiment, a plurality of large language models {LLMᵥᵢ}_{i∈[1; N]} are configured to generate variations of the test message M₁. In this example, N models are implemented. A benefit of this solution is that VARᵢ variations can be configured according to different criteria, in order to generate a test domain that is as exhaustive as possible.

Various examples are described, but the invention is not limited to these.

According to a first example, a first large LLMᵥ₁ language model is configured to generate a plurality of reformulations or paraphrases of the message M₁. This model is configured with a prompt or context to promote the production of new messages M₁ produced from a message M₁ by varying the words of the discrete symbol sequence while maintaining the meaning. To this end, in an embodiment, the modification and replacement of terms by synonyms are carried out within the M₁ message, or expression reformulations or equivalents can be produced.

According to a second example, a second large LLM language modelᵥ₂ is configured to generate a plurality of VARᵢ variations based on total or partial translations of the original M₁ message. This model is configured with a prompt or context to promote the production of new messages M₁ produced from a message M₁ by varying the translations of certain expressions or even the set of words in the sequence of discrete symbols forming the message M₁ while preserving the meaning of the latter. To this end, different languages are configured to produce variations corresponding to a plurality of translations of all or part of the M₁ message in a plurality of languages. According to an example, mixtures of translations of certain parts of the same message are produced to generate a message comprising different portions of text expressed in different languages.

According to a third example, a third major LLMV3 language model is configured to generate a plurality of VARᵢ variations based on exaggerations of the original M₁ message. This model is configured with a prompt or context to promote the production of new messages M₁ produced from a message M₁ by varying the exaggerations of certain words, phrases or sentences, or even all the words in the sequence of discrete symbols forming the message M₁. To this end, certain synonyms or equivalents which are too close to the original terms of the M₁ message are not retained, in favor of replacing terms which exaggerate a characteristic defined by the meaning of a word, or which correspond to an emphasis of a term or group of words. Exaggeration can also be applied to a figure, a value, an estimate, a percentage, a statistic or any other quantity expressed in a message. These variations correspond to a plurality of sequences capable of modifying the meaning of message M₁ or at least making it vary around the meaning defined by the first message M₁. The third major LLM_{V3} language model thus generate a modification of the following sentence “I have a problem with my computer” into “I have a big bug with my PC”.

According to a fourth example, a fourth major LLM language modelᵥ₄ is configured to generate a plurality of VARᵢ variations based on changes in the tone of the original M₁ message. This model is configured with a prompt or context to encourage the production of new messages M₁ produced from a message M₁ by varying the tones of certain groups of words, certain expressions or even certain phrases, or even all the words in the sequence of discrete symbols forming the message M₁. The changes in tone can reflect exasperation, an order, irritation, anger or even a calm masking an individual's restraint, etc.

To this end, according to an embodiment the LLMᵥ₄ is used to modify verb tenses, pronouns and intonations, or the interrogative or exclamatory form of groups of words in the sequence of discrete symbols forming the M₁

According to an embodiment, the fourth major LLMV4 language model thus generate a modification of the following sentence: “Can you help me book a train for tonight to go to Nantes from Paris? Thank you in advance” to “give me the timetable for Paris-Nantes tonight, or I'll log off forever”.

According to a fifth example, a fifth major language model LLMᵥ₅ is configured to generate a plurality of VARᵢ variations based on modifications to the message M₁ or the introduction into the original message M₁ of words from a given register, such as vulgar words or insults. This model is configured with a prompt or context to encourage the production of new messages M₁ produced from a message M₁ by varying the vocabulary of certain groups of words, certain expressions or even certain phrases, within the message M₁. In an embodiment, modifications to the message M₁ include changing words from a given register to words from another register, or introducing them without replacement.

The fifth major LLM language modelᵥ₅ can thus generate a modification of the sentence “I'd like to know the life insurance interest rates for policies taken out in the last 3 months” to “Give me the life insurance interest rates, you big fool”.

### Combining Large Language Models to Produce Variations

In an embodiment, the VARᵢ variations are produced from two cascaded LLMᵥₖ variation language models. In an embodiment, a plurality of large variation models is cascaded to produce a wide variety of heterogeneous variations.

According to this design, the output of one large variation language model is used to define an input to another large variation language model LLMᵥₖ. This configuration makes it possible to enrich the variations of the original message M₁. According to an example, the second variation language model LLM_{V2} and the third variation language model LLM_{V3} are implemented in cascade so that exaggerations of partial or total translations of the message M₁ are produced.

### Variations Produced by Other Algorithms

In an embodiment, encoding using non-conventional characters such as symbols are used to generate variations. For example, the term “Bonjour” can be encoded as follows:

[symbol]

According to one example, an encoding allowing Caesar-type codes, hexadecimal, “leetspeak”, also known as the “language of the elite” and corresponding to a writing system using ASCII alphanumeric characters in a way that is difficult for the layman to understand, are used to generate message variations.

According to another example, an algorithm designed to apply a “prompt injection” strategy is implemented in the method of the invention. Such a strategy consists in using a predefined description accompanied by examples to exploit the vulnerabilities of a language model LLMₜ. According to an example, the process implements a variation LLM to modify the M₁ message so that it uses the selected tactic.

According to an example, these strategies are configured from scientific literature, and possibly enriched with data characterizing identified vulnerabilities of an LLM.

### Variation Recording and Filtering

According to an embodiment, all the VARᵢ variations produced from the M₁ message are stored in a memory or a database for later use when testing the LLMₜ to be tested. In an embodiment, filtering is carried out to select or retain the variations that are most distinctive from one another, or to discard certain variations when a variation is too close to the original M₁ message. According to an embodiment, a predefined number of variations is configured in order to limit computing resources when testing the large language model to be tested LLMₜ.

In an embodiment, the filter consist of comparisons of the different variations and a measurement of a similarity indicator, for example, according to the number of discrete symbols differing from one variation to another. Other possibilities can be implemented to filter part of the variations in order to keep only a limited number of variations for the test phase.

### Generating Responses From the Conversational Agent to be Tested

According to an embodiment, the method of the invention comprises a step of transmitting a plurality of VARᵢ variations to a conversational agent to be tested LLMₜ to produce a plurality of responses produced by the conversational agent to be tested LLMₜ. Each response produced by the LLMₜ conversational agent constitutes a response that is unit-tested using the invention's method. In an embodiment, the tests are carried out sequentially, or are parallelized so that a plurality of instances of the conversational agent are produced.

In an embodiment, the method of the invention comprises a step of generating, noted GEN₃ on FIG. 1, a plurality of message exchanges including the variation VARᵢ and the associated response REPᵢ by applying a large language model to be tested LLMₜ.

The set formed by a VARᵢ variation and the response produced by the LLMₜ conversational agent to be tested is noted as a sequence SEQᵢ.

The method of the invention includes a test step aimed at producing two indicators IND₁ and IND₂ for testing the LLMₜ conversational agent.

The first IND₁ indicator generated is an indicator of factual error in the sequence. The second indicator IND₂ generated is an indicator of sequence conformity.

### Error Indicator

In an embodiment, the IND₁ error indicator is designed to measure the extent to which the conversational agent produces an erroneous, false or incoherent response, or a response produced by hallucination or confabulation.

According to an embodiment, to this end, a first large evaluation language model LLMₑ is used to check the outputs produced by this large evaluation model LLMₑ with the outputs produced by the large language model to be tested LLMₜ from the same input variations. In this case, the LLMᵥₖ produces a sequence comprising a variation and a response, the sequence is denoted SEQ_{VARi} and the response is compared with that of the LLMₜ test model.

Tests designed to produce or not an error indicator are marked TEST₁ in FIG. 1.

In the latter case, the prompt or context of such a large LLMₑ evaluation language model is predefined. According to an embodiment, a plurality of large evaluation language models LLMₑ, and thus if appropriate a plurality of large variation language models LLMᵥₖ, is configured to test according to different criteria the large language model to be tested LLMₜ.

According to an embodiment, in order to produce or not an error indicator IND₁, the method of the invention comprises a step of verifying that a set of concepts in common are present in the response produced by the large test language model LLMₜ and in the large variation language model LLMᵥₖ.

In an embodiment, the set of concepts is predetermined or produced from a given semantic domain, or it is produced by a large domain language model LLM₂ to which a variation of the first message M₁ has been provided, the latter having been configured with a given prompt or context with the aim of providing a list of semantic domains or fields. A benefit of the latter solution is to have an LLM trained on different data than the large language model to be tested LLMₜ.

In this way, it is possible to check that a set of expected concepts are present in the response of the large language model to be tested LLMₜ.

According to another example, the error indicator IND₁ is produced by calculating a similarity index between an answer produced by a large variation LLMᵥₖ and the answers produced by the large language model to be tested LLMₜ from the same variation considered as input to the two models LLMᵥₖ and LLMₜ. In an embodiment, a large evaluation language model LLMₑ is configured to produce the similarity index from a comparison made between the two outputs of the two models LLMᵥₖ and LLMₜ.

According to another embodiment, a similarity score is calculated from a similarity score based on the differences and similarities of the two strings produced or more generally the two sequences of discrete natural language symbols produced by the two LLMᵥₖ models and LLMₜ.

According to an embodiment, a similarity score is used to assess how the responses produced by the two models are similar or are distant. An IND₁ error indicator is generated when a threshold of the similarity index is exceeded.

Further comparators can be configured to produce an error indicator IND₁ for each response produced by the LLMₜ from a VARᵢ variation.

In a second step, the method of an embodiment of the invention enables an automatic action to be produced as a function of the generation of the IND₁ error indicator.

### Compliance Indicator

According to an embodiment, the compliance indicator IND₂ aims to measure the extent to which the LLMₜ conversational agent produces a REPᵢ response that complies with a predefined domain, known as the DOMc compliance domain. In an embodiment, the DOMc conformance domain is defined by a set of rules or a set of reference responses produced by another large conformance language model.

Tests designed to produce or not an error indicator are marked TEST₂ in FIG. 1.

According to an example, a set of rules includes specifying a response language, specifying topics to be excluded from the response field or that a link to a data network resource must be present in a given response type.

According to an embodiment, the DOMc conformance domain is defined by a set of rules generated by a conformance LLM configured to delimit a response domain. According to another example, the compliance domain is defined by the semantic field or a set of concepts generated in the responses by a compliance LLM.

According to another example, the DOMc conformance domain is defined from a set of RGL₁ rules defining validity sets of the response produced by a large language model.

According to an example, this set of RGL₁ rules defines disability sets comprising a knowledge base listing a set of themes, categories, labels or keywords each defining a sequence of discrete symbols in a natural language and possibly variations of this sequence.

### Generate Actions and Alerts

According to an embodiment, when at least one error indicator IND₁, IND₂, is generated, the method of the invention comprises a step aimed at performing an action automatically. According to a first example, the action corresponds to the generation of a notification, such as an alert.

According to an embodiment, notifications are produced as soon as at least one error indicator or at least one compliance indicator is produced. According to another example, a data item is notified, showing the number of errors and/or the statistics for the occurrence of these errors.

In an example, a notification is sent to a server for administering and testing the conversational agent.

According to another example, the action is an automated response produced by the conversational agent. For example, the conversational agent might generate a response such as “An error has been detected in our conversation, could you please rephrase your question”, for example, within a user interface.

According to another example, the automatically generated action is an update to take into account new data sources to regenerate or update the conversational agent prompt.

According to another example, the action is the generation of a command to activate the execution of a computer program aimed, for example, at suspending the production of the conversational agent or switching back the assistance function with a human or any other software function modifying the operation of the conversational agent.

### System

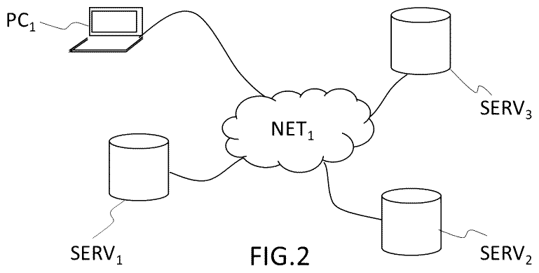

FIG. 2 shows an example of the infrastructure used to implement the invention. A SERV₁ server is used to calculate error and compliance indicators.

According to an example of the invention's architecture, a second server is a server hosting at least one Sᵢ data source, and the SERV₃ server is a server for displaying compliance and error indicator values over time, said SERV₃ server being accessible from a solution administration console.

According to an embodiment, the method of the invention is implemented by means of computer-readable instructions. According to an implementation, one or more computers and more specifically one or more processors, such as a microprocessor and/or an electronic circuit, is/are configured to implement the method of the invention.

During execution of the process, computer-readable instructions generate commands and results through numerical calculations, enabling the steps of the invention to be carried out. One or more memories are then used to store data and use it to produce commands or results when executing the process of the invention.

It will be appreciated that the various aspects of the invention described herein provide a concrete and specific technical solution to a technical problem: ensuring the robustness and reliability of large language models (LLMs) implemented in conversational agents over time. The issue arises from the dynamic nature of data sources, the diversity of input forms, and the potential degradation of performance due to evolving linguistic or contextual factors. The disclosed method systematically addresses this by automatically generating tests using a plurality of variation language models configured with specific contexts and rules. This structured approach ensures the conversational agent remains accurate and robust across varying domains and user inputs.

It will also be appreciated that the disclosed method is not a mere abstract idea; it is implemented through a tangible process involving specific steps and components. These include the automated extraction and normalization of data from predefined sources, configuration of LLM contexts for variation generation, and the application of a secondary evaluation mechanism using independent evaluation models. In an implementation, the method employs a system architecture comprising multiple servers (SERV₁, SERV₂, etc.) that are explicitly configured to perform distinct computational and evaluative functions, demonstrating a concrete and specific technological framework for achieving the desired outcomes.

Various aspects of the invention provide a marked improvement in the technical field of conversational agents by enhancing their ability to respond effectively to dynamic and evolving data contexts. For example:
The method automates the generation of diverse test scenarios, enabling scalability in evaluating conversational agents without manual intervention;
By employing independent evaluation models to cross-check outputs, aspects of the invention significantly reduce instances of errors, hallucinations, or incoherent responses, ensuring reliability;
The use of variation language models tailored to specific domains and linguistic nuances allows the conversational agent to adapt dynamically to varied user requirements;
The technical improvements ensure that conversational agents provide consistent, contextually relevant, and accurate responses, directly benefiting end users.

Aspects of the invention are not abstract but tied closely to the technological implementation involving specific hardware and software integrations. In an implementation, the system employs interconnected data servers for data extraction, processing, and storage, combined with computational models running in distinct environments. The use of predefined rules, prompts, and configurations to generate, test, and evaluate model outputs demonstrates a specific, non-generic application of AI technology.

Consider a scenario where an organization employs a conversational agent for customer support in the insurance domain. The disclosed invention ensures that the agent can dynamically adapt to updated policies or regulatory changes by continuously testing its responses against evolving datasets. For instance, the system could generate a test query, “Can I claim full reimbursement for a hospital visit under the updated plan?” Variations of this question, including paraphrases, linguistic shifts, or tone changes, are tested, ensuring the agent's response remains accurate and reliable.

In one or more embodiments, the device for executing the variation language models is implemented through a distributed server architecture comprising:
A Primary Data Server (SERV1), which is responsible for receiving, storing, and pre-processing data sets extracted from various sources. This server normalizes and formats input data, preparing it for model processing, and
Variation Model Server (SERV3) equipped with specialized processors and memory resources, this server executes the variation language models (LLMvk). Each LLMvk is parameterized to generate specific variations such as paraphrases, translations, tone adjustments, and linguistic modifications. These models operate based on distinct contextual prompts configured for each variation type.

In one or more embodiments, the system includes dedicated computational units, such as GPUs or TPUs, optimized for running deep learning models. These units may be hosted within SERV3 and execute the variation language models, leveraging parallelized processing to handle multiple test inputs simultaneously. Each computational unit may apply model weights trained on domain-specific datasets, generate outputs through a sequence of matrix computations and token-level predictions, and optimize response generation by applying predefined constraints and error-checking algorithms during execution.

The device for executing the variation models may include software modules designed to load pretrained variation language models into memory, configure model prompts dynamically, allowing customization of outputs based on linguistic, cultural, or domain-specific requirements. (for example, a context module may introduce predefined keywords or lexical fields into the prompt to ensure relevance to a given domain), and manage model execution pipelines, where outputs from one variation model (e.g., LLMvk for paraphrasing) feed into another variation model (e.g., LLMvk for tone modulation) to produce cascaded variations.

In one or more embodiments, each model is configured with its unique function, such as, for example:
LLMv1 for paraphrasing: LLMv1 generates semantically equivalent reformulations of test queries;
LLMv2 for translation: LLMv2 converts input queries into various languages, adhering to specified grammatical and contextual nuances;
LLMv3 for exaggeration: LLMv3 amplifies specific aspects of input data, such as emphasizing urgency or emotional intensity, and
LLMv4 for tone adjustment: LLMv4 alters the tone to fit predefined scenarios, such as formal or informal communication styles.

In one or more embodiments, the device for executing the variation language models may utilize scalable cloud-based infrastructure, such as, for example, cloud-hosted servers dynamically allocate computing resources to execute LLMvk instances, virtual machine clusters provide redundancy and scalability to handle large volumes of test data and containerized environments ensure reproducibility and isolation of different language models during execution.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A person skilled in the art will readily appreciate that various features, elements, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

What is claimed is:

1. A computer-implemented method for testing the performance of a large language model implemented within a conversational agent, the method comprising:
receiving a data set from at least one data source, said data corresponding to an encoding of sequences of discrete symbols in natural language, the data set being previously extracted from at least the data source automatically according to a given frequency and from a selection of a predefined natural language;
generating at least a first test message from the received data set and by application of at least a first large language model configured with a main context comprising a definition of a language and a given instruction specific to the data source;
generating a plurality of variation sequences by applying at least one plurality of large variation language models configured from a plurality of secondary contexts making it possible to generate, on the one hand, the variations of the first test message and the associated responses generated by at least one large language model;
generating a plurality of message sequences by application of a large language model to be tested, a sequence comprising an input and the corresponding generated output of a large language model;
calculating a first error indicator evaluating a set of error criteria by comparing sequences produced by the large language model to be tested and variation sequences;
calculating a second conformance indicator from a conformance domain containing conformance rules defining validity sets for sequences produced by the large language model to be tested,
generating an alert when at least a first error indicator and/or a second compliance indicator is generated.

2. The method according to claim 1, wherein the variation sequence responses are generated by the plurality of large variation language models.

3. The method according to claim 1, wherein the responses of the sequences of variations are generated by at least one large evaluation language model considering as input a variation produced by a large variation language model and producing as output an associated response.

4. The method according to claim 1, wherein the predefined frequency is used to select data from data sources published from a given date.

5. The method according to claim 1, wherein the data source is pre-selected from a uniform resource locator within a data network and an organization name for selecting a sub-part of the data accessible from the uniform resource locator.

6. The method according to claim 1, wherein the data reception comes from one of the data sources characterized by:
a data source accessible from a social network using an authentication process;
a data source defining comments or opinions from a plurality of individuals,
an open-access information data source.
a data source defining one or more databases internal to an organization, such as a product or item database, a service database, or a stock vehicle database;
a data source defining conversational agent(s) conversation data
recorded in production or in a test environment,
a data source defining electronic documentation.

7. The method according to claim 1, comprising executing a large source data processing language model in order to filter, format and/or normalize the data sets extracted from the data sources.

8. The method according to claim 1, wherein each exchange sequence comprises a sequence of natural language symbols defining a question, said sequence of natural language symbols being generated from at least a first large variation language model and an answer generated by using a large test language model.

9. The method according to claim 1, wherein the main context of a first large variation language model comprises the definition of a domain associated with a lexical field or a set of keywords.

10. The method according to claim 1, wherein a first large variation language model comprises a context configured to automatically generate a sequence of discrete symbols in a natural language from one or more paraphrases of the first message.

11. The method according to claim 1, wherein a second large variation language model comprises a context configured to automatically generate a sequence of discrete symbols in a natural language from a translation of the first message into another natural language.

12. The method according to claim 1, wherein a third large variation language model comprises a context configured to automatically generate a sequence of discrete symbols in a natural language from an exaggeration of the first message.

13. The method according to claim 1, wherein a fourth large variation language model comprises a context configured to automatically generate a sequence of discrete symbols in a natural language from a change in tone of the first message.

14. The method according to claim 1, wherein a fifth large variation language model comprises a context configured to automatically generate a sequence of discrete symbols in a natural language from an introduction of at least one insult in the first message.

15. The method according to claim 1, wherein a sixth large variation language model comprises a context configured to automatically generate a sequence of discrete symbols in a natural language from an introduction of at least one error in the first message, said error being for example a spelling or grammatical error in a natural language.

16. The method according to claim 1, comprising generating a plurality of message variations for each large language variation model.

17. The method according to claim 1, wherein the conformance domain is defined from the response of a third large language model configured from a context defining a conformance domain.

18. The method according to claim 1, wherein the conformance domain is defined from a set of rules defining validity sets of predefined natural language symbol sequences and/or invalidity sets of predefined natural language symbol sequences.

19. The method according to claim 1, wherein the set of rules comprises the specification of a response language, the specification of topics to be excluded from the response field or that a link to a data network resource being present in a given response type.

20. The method according to claim 1, wherein the set of rules defining invalidity sets comprises a knowledge base listing a set of themes, categories, labels or keywords each defining a sequence of discrete symbols in a natural language and possibly variations of this sequence.

21. The method according to claim 1, wherein the conformance domain is generated in part automatically from the organization name, rules and main context of the first large language model.

22. The method according to claim 1, wherein an error criterion of the first error indicator comprises a check that a set of concepts in common are present on the one hand in the response produced by the variation sequence produced and on the other hand in the response produced by the large language model to be tested to which a variation of the first message has been supplied.

23. The method according to claim 1, wherein when an error indicator and/or a compliance indicator is generated, a notification is automatically sent to a remote server or a memory resource of a piece of equipment on which the process is run.

24. The method according to claim 1, wherein when an error indicator and/or a compliance indicator is generated, an error counter is generated to produce an evaluation of the conversational agent over a given period.

25. A system comprising an electronic user terminal with a user interface, at least one data server hosting all or part of a first data source, a second data server comprising at least one computer and a memory in which the large language model to be tested is executed, and at least one third data server comprising a device for executing a variation language model and comprising a computer for executing the method steps of claim 1.

26. The system according to claim 25, comprising a fourth data server comprising at least one computer and a memory within which the large evaluation language model is executed.
